(19) United States
(12) Patent Application Publication
(10) Pub. No.: US 2026/0004697 A1
(43) Pub. Date: Jan. 1, 2026

(54) CONTROLLER, DISPLAY DEVICE INCLUDING THE SAME, AND ELECTRONIC DEVICE INCLUDING THE SAME

(71) Applicant: Samsung Display Co., Ltd., Yongin-si (KR)

(72) Inventors: Jin Pil KIM, Yongin-si (KR); Jong Woong PARK, Yongin-si (KR); Won Bok Lee, Yongin-si (KR)

(21) Appl. No.: 19/210,565

(22) Filed: May 16, 2025

(30) Foreign Application Priority Data
Jun. 26, 2024 (KR) 10-2024-0083790

(51) Int. Cl. G09G 3/20

(52) U.S. Cl. CPC G09G 3/2074; G09G 2300/0819; G09G 2300/0842; G09G 2330/021; G09G 2360/16

(57) ABSTRACT

A controller includes: an input image data reception circuit configured to receive input image data including a grayscale value of a pixel; a representative value calculation circuit configured to calculate an on-pixel ratio from the received input image data; a weighting calculation circuit configured to calculate a weighting corresponding to the input image data based on the calculated on-pixel ratio; and an image data output circuit configured to output image data generated by multiplying the input image data by the calculated weighting.

### CROSS-REFERENCE TO RELATED APPLICATION

The present application claims priority to and the benefit of Korean Patent Application No. 10-2024-0083790 filed in the Korean Intellectual Property Office on Jun. 26, 2024, the entire disclosure of which is incorporated herein by reference.

### BACKGROUND

### 1. Field

Aspects of some embodiments of the present disclosure relate to a controller, a display device including the same, and an electronic device including the same.

### 2. Description of the Related Art

As information technologies develop, the importance of display devices, which provide a connection medium between users and information, is emerging. In response, the use of display devices such as liquid crystal display devices and organic light-emitting display devices is increasing.

Research is being conducted on methods capable of lowering the power consumption of a display device within a range in which the display quality of images displayed by the display device are not degraded.

The above information disclosed in this Background section is only for enhancement of understanding of the background and therefore the information discussed in this Background section does not necessarily constitute prior art.

### SUMMARY

Aspects of some embodiments of the present disclosure include a controller capable of lowering the power consumption of a display device within a range in which the display quality of images displayed by the display device is not degraded, a display device, and an electronic device including the same.

According to some embodiments of the present disclosure, a controller includes: an input image data reception circuit configured to receive input image data including a grayscale value of a pixel, a representative value calculation circuit configured to calculate an on-pixel ratio from the received input image data, a weighting calculation circuit configured to calculate a weighting corresponding to the input image data based on the calculated on-pixel ratio, and an image data output circuit configured to output image data generated by multiplying the input image data by the calculated weighting.

According to some embodiments, the input image data reception circuit may receive input image data of an N^{th} frame (N is an integer of 1 or more) and input image data of an (N+1)^{th} frame and may determine whether the received input image data of the N^{th} frame is the same as the received input image data of the (N+1)^{th} frame.

According to some embodiments, based on the input image data of the N^{th} frame being the same as the input image data of the (N+1)^{th} frame, the weighting calculation circuit may calculate 1 as a weighting corresponding to the input image data of the (N+1)^{th} frame.

According to some embodiments, based on the input image data of the N^{th} frame being different from the input image data of the (N+1)^{th} frame, the representative value calculation circuit may calculate an on-pixel ratio of the N^{th} frame and an on-pixel ratio of the (N+1)^{th} frame.

According to some embodiments, the weighting calculation circuit may read a first input value corresponding to the on-pixel ratio of the N^{th} frame and the on-pixel ratio of the (N+1)^{th} frame with reference to a two-dimensional lookup table and may input a prestored weighting of the N^{th} frame and the read first input value to a low-pass filter.

According to some embodiments, the weighting calculation circuit may calculate an output value calculated in the low-pass filter as a weighting of the (N+1)th frame.

According to some embodiments, the weighting calculation circuit may calculate an output value calculated in the low-pass filter as a second input value and may determine whether the prestored weighting of the N^{th} frame is the same as the second input value.

According to some embodiments, based on the prestored weighting of the N^{th} frame being the same as the second input value, the weighting calculation circuit may calculate the second input value as a weighting of the (N+1)^{th} frame.

According to some embodiments, based on the prestored weighting of the N^{th} frame being different from the second input value, the weighting calculation circuit may further receive a luminance control signal and may calculate the on-pixel ratio of the (N+1)^{th} frame and the received luminance control signal to calculate a current on-pixel ratio.

According to some embodiments, the weighting calculation circuit may calculate an output value corresponding to the current on-pixel ratio as a weighting of the (N+1)^{th} frame with reference to a one-dimensional lookup table.

According to some embodiments of the present disclosure, a display device includes a display panel on which a plurality of pixels are located, a data driver configured to receive image data and supply data signals to data lines connected to the plurality of pixels based on the received image data, and a controller configured to receive input image data, calculate an on-pixel ratio from the received input image data, calculate a weighting corresponding to the input image data based on the calculated on-pixel ratio, and output image data generated by multiplying the input image data by the calculated weighting.

According to some embodiments, the controller may receive input image data of an N^{th} frame (N is an integer of 1 or more) and input image data of an (N+1)th frame and may determine whether the received input image data of the N^{th} frame is the same as the received input image data of the (N+1)^{th} frame.

According to some embodiments, based on the input image data of the N^{th} frame being the same as the input image data of the (N+1)^{th} frame, the controller may calculate 1 as a weighting corresponding to the input image data of the (N+1)^{th} frame.

According to some embodiments, based on the input image data of the N^{th} frame being different from the input image data of the (N+1)^{th} frame, the controller may calculate an on-pixel ratio of the N^{th} frame and an on-pixel ratio of the (N+1)^{th} frame.

According to some embodiments, the controller may read a first input value corresponding to the on-pixel ratio of the N^{th} frame and the on-pixel ratio of the (N+1)th frame with reference to a two-dimensional lookup table and may input a prestored weighting of the N^{th} frame and the read first input value to a low-pass filter.

According to some embodiments, the two-dimensional lookup table may be stored in the controller, wherein, in the stored two-dimensional lookup table, when the on-pixel ratio of the N^{th} frame is the same or similar to the on-pixel ratio of the (N+1)th frame, the first input value has a value of 1, and when the on-pixel ratio of the N^{th} frame is not the same or similar to the on-pixel ratio of the (N+1)^{th} frame, the first input value has a value that is less than 1.

According to some embodiments, the low-pass filter may be a Kalman filter.

According to some embodiments, the controller may calculate an output value calculated in the low-pass filter as a weighting of the (N+1)^{th} frame.

According to some embodiments, the controller may calculate an output value calculated from the low-pass filter as a second input value and may determine whether the prestored weighting of the N^{th} frame is the same as the second input value.

According to some embodiments, based on the prestored weighting of the N^{th} frame being the same as the second input value, the controller may calculate the second input value as a weighting of the (N+1)^{th} frame, and based on the prestored weighting of the N^{th} frame being different from the second input value, the controller may further receive a luminance control signal and may calculate the on-pixel ratio of the (N+1)^{th} frame and the received luminance control signal to calculate a current on-pixel ratio.

According to some embodiments of the present disclosure, an electronic device including a processor configured to output an input image data, a display panel on which a plurality of pixels are located, a data driver configured to receive image data and supply data signals to data lines connected to the plurality of pixels based on the received image data, and a controller configured to receive the input image data, to calculate an on-pixel ratio from the received input image data, to calculate a weighting corresponding to the input image data based on the calculated on-pixel ratio, and to output the image data generated by multiplying the input image data by the calculated weighting.

### BRIEF DESCRIPTION OF THE DRAWINGS

FIG. 1 is a system block diagram of a display device according to some embodiments of the present disclosure.

FIG. 2 is a block diagram illustrating aspects of a subpixel of subpixels of FIG. 1 according to some embodiments.

FIG. 3 is an equivalent circuit diagram of the subpixel of FIG. 2 according to some embodiments.

FIG. 4 is a view illustrating an example image being displayed during consecutive frame periods according to some embodiments.

FIGS. 5A, 5B, and 5C are views for describing an on-pixel ratio.

FIG. 6 is a view illustrating an example still image being displayed during consecutive frame periods.

FIG. 7 is a graph showing that luminance is maintained constant while a still image is displayed according to some embodiments of the present disclosure.

FIG. 8 is a view illustrating an example moving image with the same or similar on-pixel ratio in consecutive frame periods.

FIG. 9 is a graph showing that luminance decreases while a moving image with the same or similar on-pixel ratio is displayed according to some embodiments of the present disclosure.

FIG. 10 is a flowchart illustrating a method of driving a display device according to some embodiments of the present disclosure.

FIG. 11 is a flowchart illustrating aspects of a method of calculating a weighting of an (N+1)^{th} frame according to some embodiments.

FIG. 12 illustrates aspects of a two-dimensional lookup table according to some embodiments.

FIG. 13 illustrates aspects of a low-pass filter according to some embodiments.

FIG. 14 is a diagram illustrating a relationship between widths of a luminance control signal and an emission control signal according to some embodiments.

FIGS. 15A, 15B, and 15C are views for describing a relationship between a luminance control signal, an on-pixel ratio, and a current on-pixel ratio.

FIGS. 16A and 16B are views illustrating an example change in image luminance according to a change in current on-pixel ratio.

FIGS. 17A and 17B are graphs showing that a luminance change amount varies according to a current on-pixel ratio according to some embodiments of the present disclosure.

FIG. 18 is a flowchart showing aspects of a method of calculating a weighting of an (N+1)^{th} frame according to some embodiments.

FIG. 19 illustrates aspects of a one-dimensional lookup table according to some embodiments.

FIG. 20 is a block diagram showing aspects of a controller according to some embodiments of the present disclosure.

FIG. 21 is a block diagram of an electronic device according to an embodiment of the present disclosure.

FIG. 22 is a schematic diagram of an electronic device according to various embodiments.

### DETAILED DESCRIPTION

Hereinafter, aspects of some embodiments of the present disclosure will be described in more detail with reference to the accompanying drawings so that those skilled in the art may easily practice the present disclosure. It should be understood that embodiments according to the present disclosure may be embodied in different ways and is not limited to the following embodiments.

In order to more clearly describe the present disclosure, portions not related to the description will be omitted. Like components will be denoted by like reference numerals throughout the specification. Therefore, the reference numerals described above may also be used in other drawings.

In addition, the sizes and thicknesses of the respective components shown in the drawings are arbitrarily shown for convenience of description, and thus one or more embodiments are not necessarily limited thereto. In the drawings, the thicknesses of layers and regions are exaggerated for clarity.

In addition, in the description, the expression “is the same” may mean “substantially the same.” That is, it may be the same enough to convince those of ordinary skill in the art to be the same. In other expressions, “substantially” may be omitted.

The terms, “first,” “second,” and the like may be simply used for description of various constituent elements, but those meanings may not be limited to the restricted meanings. The above terms are used only for distinguishing one constituent element from other constituent elements. For example, a first constituent element may be referred to as a second constituent element and similarly, the second constituent element may be referred to as the first constituent element without departing from the scope of the present disclosure. An expression of a singular number includes an expression of the plural number, so long as it is clearly read differently.

Terms such as “below,” “lower,” “on,” and “upper” are used to describe a relationship of configurations shown in the drawing. These terms are described as a relative concept based on an orientation shown in the drawing.

Unless otherwise defined, all terms (including technical and scientific terms) used herein have the same meaning as terms commonly understood by those skilled in the art to which the present disclosure pertains. In addition, it will be further understood that terms, such as those defined in commonly used dictionaries, should be interpreted as having a meaning that is consistent with their meaning in the context of the relevant art and will not be interpreted in an idealized or overly formal sense unless expressly so defined herein.

The term “comprise” or “has” is used to specify existence of a feature, a numbers, a process, an operation, a constituent element, a part, or a combination thereof, and it will be understood that existence or additional possibility of one or more other features or numbers, processes, operations, constituent elements, parts, or combinations thereof are not excluded in advance.

As used herein, the term “connected” may include not only a physical connection, but also an electrical connection.

Hereinafter, aspects of some embodiments of the present disclosure will be described in more detail with reference to the accompanying drawings.

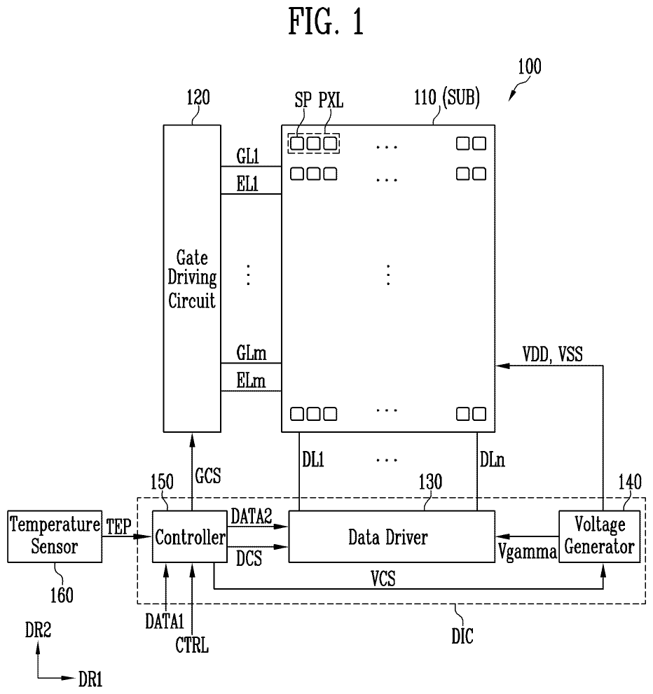

FIG. 1 is a system block diagram of a display device 100 according to some embodiments of the present disclosure.

Referring to FIG. 1, the display device 100 according to some embodiments of the present disclosure may include a display panel 110, a gate driving circuit 120, a data driver 130, a voltage generator 140, a controller 150, and a temperature sensor 160.

The display panel 110 may include a plurality of subpixels SP. First to m^{th} gate lines GL1 to GLm (m is an integer of 2 or more) connected to the plurality of subpixels SP may be located on the display panel 110. First to n^{th} data lines DL1 to DLn (n is an integer of 2 or more) connected to the plurality of subpixels SP may be located on the display panel 110.

The plurality of subpixels SP may be connected to the gate driving circuit 120 through the first to m^{th} gate lines GL1 to GLm. The plurality of subpixels SP may be connected to the data driver 130 through the first to n^{th} data lines DL1 to DLn.

Each of the plurality of subpixels SP may include one or more light-emitting elements configured to generate light. Each of the plurality of subpixels SP may generate light with a color such as red, green, blue, cyan, magenta, or yellow (for example, light with a specific color or light in a specific wavelength band). Two or more subpixels among the plurality of subpixels SP may constitute one pixel PXL. For example, as shown in FIG. 1, three subpixels may constitute one pixel PXL.

The gate driving circuit 120 may be connected to the plurality of subpixels SP (for example, the plurality of subpixels SP arranged in a first direction DR1 as a whole) through the first to m^{th} gate lines GL1 to GLm. For example, the first direction DR1 may be a direction crossing the display panel 110 from one side (for example, a left side) to the other side (for example, a right side). For example, the first direction DR1 may be a row direction.

In response to a gate control signal GCS, the gate driving circuit 120 may output gate signals (for example, gate signals with a turn-on level or a turn-off level) to the first to m^{th} gate lines GL1 to GLm. According to some embodiments, the gate control signal GCS may include a start signal indicating the start of each frame, a horizontal synchronization signal for outputting gate signals in synchronization with a timing at which data signals are applied, and the like.

According to some embodiments, first to m^{th} emission control lines EL1 to ELm connected to the plurality of subpixels SP may be further located on the display panel 110. The first to m^{th} emission control lines EL1 to ELm may be arranged to extend in the row direction in the display panel 110. The plurality of subpixels SP may be connected to the first to m^{th} emission control lines EL1 to ELm. According to some embodiments, the gate driving circuit 120 may include an emission control driver configured to control the first to m^{th} emission control lines EL1 to ELm. The emission control driver may operate under the control of the controller 150.

The gate driving circuit 120 may be located at one side of the display panel 110. However, embodiments according to the present disclosure are not limited thereto. For example, the gate driving circuit 120 may be divided into two or more physically and/or logically separated driving circuits or components, and such driving circuits or components may be positioned at one side and the other side (for example, the other side opposite to the one side of the display panel 110) in the display panel 110. As such, the gate driving circuit 120 may be arranged in various forms in the display panel 110 or around the display panel 110 according to some embodiments.

The data driver 130 may be connected to the plurality of subpixels SP through the first to n^{th} data lines DL1 to DLn. For example, the second direction DR2 may be a direction crossing the display panel 110 from one side (for example, a lower side) to the other side (for example, an upper side). For example, the second direction DR2 may be a column direction.

The data driver 130 may receive image data DATA2 and a data control signal DCS from the controller 150. The data driver 130 may operate in response to the data control signal DCS. According to some embodiments, the data control signal DCS may include a source start pulse signal, a source shift clock signal, a source output enable signal, or the like.

By using voltages (for example, gamma voltage Vgamma) from the voltage generator 140, the driver 130 may apply data signals, which have grayscale voltages corresponding to the image data DATA2, to the first to n^{th} data lines DL1 to DLn. When a gate signal (for example, a gate signal with a turn-on level) is applied to each of the first to m^{th} gate lines GL1 to GLm, data signals corresponding to the image data DATA2 may be applied to the data lines DL1 to DLn. Each of the plurality of subpixels SP may receive a data signal applied at a corresponding timing in response to a gate signal (for example, a gate signal with a turn-on level). The plurality of subpixels SP may generate light corresponding to an input data signal. Accordingly, an image may be displayed on the display panel 110.

According to some embodiments, the gate driving circuit 120 and the data driver 130 may each include complementary metal-oxide semiconductor (CMOS) circuit elements.

The voltage generator 140 may operate in response to a voltage control signal VCS from the controller 150. The voltage generator 140 may be configured to generate a plurality of voltages and provide the generated voltages to components of the display device 100. For example, the voltage generator 140 may receive an input voltage from the outside of the display device 100. The voltage generator 140 may adjust (for example, lower) a level of a received voltage and regulate the level-adjusted voltage. The voltage generator 140 may be configured to generate a plurality of voltages.

For example, the voltage generator 140 may generate a first power voltage VDD, a second power voltage VSS, and the gamma voltage Vgamma. The generated first and second power voltages VDD and VSS may be applied (for example, commonly applied) to the plurality of subpixels SP. The first power voltage VDD may have a relatively high voltage level. The second power voltage VSS may have a lower voltage level than the first power voltage VDD. The generated gamma voltage Vgamma may be provided to the data driver 130. According to some embodiments, at least one of the first power voltage VDD or the second power voltage VSS may be provided by an external device (for example, a power management integrated circuit (PMIC)) of the display device 100.

According to some embodiments, the voltage generator 140 may generate different voltages. For example, the voltage generator 140 may generates initialization voltages (for example, a first initialization voltage and a second initialization voltage) that are applied (for example, commonly applied) to the plurality of subpixels SP. For example, during a sensing operation of sensing electrical characteristics of transistors and/or the light-emitting element(s) of the plurality of subpixels SP, a certain reference voltage may be applied to the first to n^{th} data lines DL1 to DLn, and the voltage generator 140 may generate such a reference voltage.

The controller 150 may be configured to control the overall operation of the display device 100. The controller 150 may receive input image data DATA1 and a control signal CTRL for controlling the display of the input image data DATA1 from the outside. The controller 150 may provide the gate control signal GCS, the data control signal DCS, and the voltage control signal VCS in response to the received control signal CTRL.

The controller 150 may output image data DATA2 by converting the input image data DATA1 to be suitable for the display device 100 or display panel 110. According to some embodiments, the controller 150 may output the image data DATA2 by aligning the input image data DATA1 to be suitable for the subpixels SP in a row unit.

Two or more components of the data driver 130, the voltage generator 140, and the controller 150 may be mounted on one integrated circuit. As shown in FIG. 1, the data driver 130, the voltage generator 140, and the controller 150 may be included in a driver integrated circuit DIC. In this case, the data driver 130, the voltage generator 140, and the controller 150 may be components functionally separated in one driver integrated circuit DIC. According to some embodiments, at least one of the data driver 130, the voltage generator 140, or the controller 150 is mounted in the driver integrated circuit DIC, and the other thereof may be provided to be mounted in an integrated circuit that is different from the driver integrated circuit DIC.

The temperature sensor 160 is configured to detect a temperature (for example, a temperature therearound) and generate temperature data TEP indicating the detected temperature. According to some embodiments, the temperature sensor 160 may be located on the display panel 110. According to some embodiments, the temperature sensor 160 may be located adjacent to the display panel 110 and/or the driver integrated circuit DIC. According to some embodiments, the display device 100 may include two or more temperature sensors 160.

The controller 150 may control various operations of the display device 100 in response to the temperature data TEP. According to some embodiments, the controller 150 may adjust the luminance of an image output from the display panel 110 in response to the temperature data TEP. For example, the controller 150 may control components such as the data driver 130 and/or the voltage generator 140 to adjust at least one of data signals input to the display panel 110, the first power voltage VDD, or the second power voltage VSS.

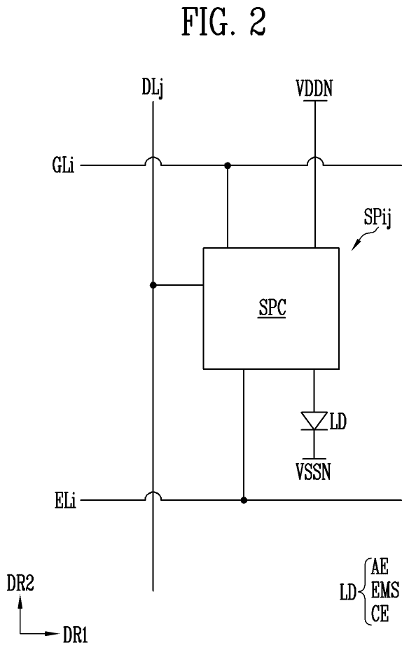

FIG. 2 is a block diagram illustrating aspects of any one subpixel SPij of the subpixels of FIG. 1 according to some embodiments.

In FIG. 2, among the plurality of subpixels SP shown in FIG. 1, the subpixel SPij located on an i^{th} row (i is an integer of 1 or more) and a j^{th} column (j is an integer of 1 or more) is shown.

Referring to FIG. 2, the subpixel SPij may include a subpixel circuit SPC and a light-emitting element LD.

The light-emitting element LD may be connected between a first power voltage node VDDN and a second power voltage node VSSN. The first power voltage node VDDN may be a node to which the first power voltage VDD of FIG. 1 is applied.

The second power voltage node VSSN may be a node to which the second power voltage VSS of FIG. 1 is applied.

The light-emitting element LD may include a first electrode, an emission structure EMS, and a second electrode. The first electrode may be any one of an anode AE and a cathode CE of the light-emitting element LD. The second electrode may be the other of the anode AE and the cathode CE of the light-emitting element LD. For convenience of description, an example in which the first electrode of the light-emitting element LD is the anode AE, and the second electrode of the light-emitting element LD is the cathode CE will be described below.

The anode AE of the light-emitting element LD may be connected to the first power voltage node VDDN through the subpixel circuit SPC. The cathode CE of the light-emitting element LD may be connected to the second power voltage node VSSN. For example, the anode AE of the light-emitting element LD may be connected to the first power voltage node VDDN through one or more transistors included in the subpixel circuit SPC.

The subpixel circuit SPC of the subpixel SPij may be connected to an i^{th} gate line GLi among the first to m^{th} gate lines GL1 to GLm of FIG. 1. The subpixel circuit SPC of the subpixel SPij may be connected to an i^{th} emission control line ELi among the first to m^{th} emission control lines EL1 to ELm of FIG. 1. The subpixel circuit SPC of the subpixel SPij may be connected to a j^{th} data line DLj among the first to n^{th} data lines DL1 to DLn of FIG. 1. The subpixel circuit SPC is configured to control an emission timing and/or emission luminance of the light-emitting element LD according to (or in response to) signals received through such signal lines.

The subpixel circuit SPC may operate in response to a gate signal received through the i^{th} gate line GLi. The subpixel circuit SPC may operate in response to an emission control signal received through the i^{th} emission control line ELi.

The subpixel circuit SPC may7receive a data signal through the j^{th} data line DLj. In response to a gate signal (for example, a gate signal with a turn-on level) received through the i^{th} gate line GLi, the subpixel circuit SPC may store a voltage of a data signal (or a voltage corresponding to the data signal). In response to an emission control signal (for example, an emission control signal with a turn-off level) applied through the i^{th} emission control line ELi, the subpixel circuit SPC may adjust a timing at which a current flows in the light-emitting element LD. A magnitude of a current flowing in the light-emitting element LD may vary according to a voltage stored in the subpixel circuit SPC. The light-emitting element LD may generate light with a luminance corresponding to a data signal.

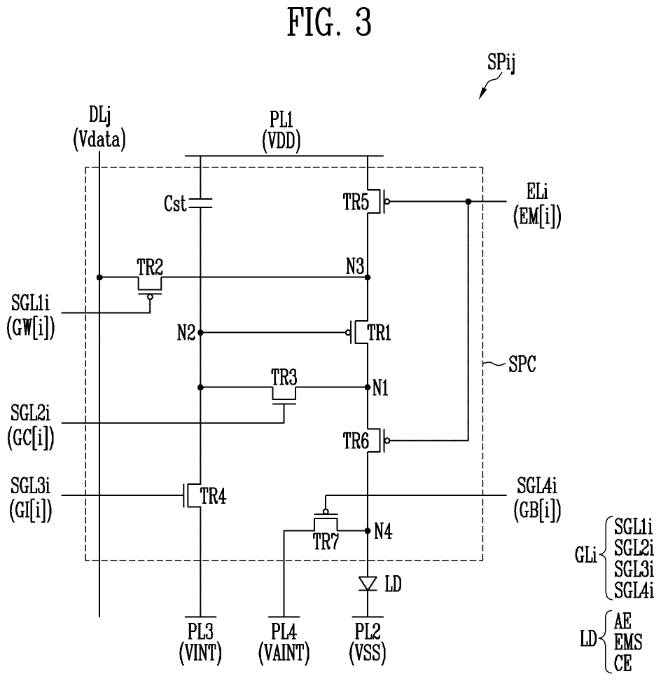

FIG. 3 is an equivalent circuit diagram of the subpixel SPij of FIG. 2 according to some embodiments. Although FIG. 3 illustrates various components in a subpixel according to some embodiments, embodiments according to the present disclosure are not limited thereto, and according to some embodiments, the subpixel may include additional components or fewer components without departing from the spirit and scope of embodiments according to the present disclosure.

The subpixel circuit SPC may be connected to the light-emitting element LD.

The subpixel circuit SPC according to some embodiments of the present disclosure may include two or more switching elements (for example, transistors) and one or more storage elements (for example, capacitors). As an example, the subpixel circuit SPC according to some embodiments of the present disclosure may include seven transistors and one capacitor. However, embodiments of the present disclosure are not limited thereto. Hereinafter, for convenience of description, according to some embodiments of the present disclosure, embodiments in which seven transistors and one capacitor are included will be described.

Referring to FIG. 3, the subpixel circuit SPC according to some embodiments of the present disclosure may include first to seventh transistors TR1 to TR7 and a storage capacitor Cst.

The first transistor TR1 may include a first electrode connected to a first node N1, a gate electrode connected to a second node N2, and a second electrode connected to a third node N3. The first electrode may be any one (for example, a drain electrode) of a source electrode and the drain electrode. The second electrode may be the other (for example, the source electrode) of the source electrode and the drain electrode. The first transistor TR1 may be configured to supply a current (for example, a driving current) corresponding to a magnitude of a voltage applied to the second node N2.

The second transistor TR2 may be configured to switch the electrical connection between the third node N3 and the j^{th} data line DLj. The second transistor TR2 may include a gate electrode connected to an i^{th} first sub-gate line SGL1i (hereinafter also abbreviated as first sub-gate line SGL1i) to which a first gate signal GW[i] is applied. In response to the first gate signal GW[i] with a turn-on level, the second transistor TR2 may electrically connect the j^{th} data line DLj and the third node N3.

The third transistor TR3 may be configured to switch the electrical connection between the first node N1 and the second node N2. The third transistor TR3 may include a gate electrode connected to an i^{th} second sub-gate line SGL2i (hereinafter also abbreviated as second sub-gate line SGL2i) to which a second gate signal GC [i] is applied. The third transistor TR3 may electrically connect the first node N1 and the second node N2 in response to the second gate signal GC [i] with a turn-on level. When the third transistor TR3 is turned on, the first transistor TR1 may be connected in the form of a diode.

The fourth transistor TR4 may be configured to switch the electrical connection between the second node N2 and a third power line PL3. A first initialization voltage VINT may be applied to the third power line PL3. The fourth transistor TR4 may include a gate line connected to an i^{th} third sub-gate line SGL3i (hereinafter abbreviated as third sub-gate line SGL3i) to which a third gate signal GI [i] is applied. The fourth transistor TR4 may electrically connect the second node N2 and the third power line PL3 in response to the third gate signal GI [i] with a turn-on level.

The fifth transistor TR5 may be configured to switch the electrical connection between the third node N3 and a first power line PL1. The first power voltage VDD may be applied to the first power line PL1. The fifth transistor TR5 may include a gate electrode connected (for example, electrically connected) to the i^{th} emission control line ELi (hereinafter abbreviated as emission control line ELi) to which an emission control signal EM [i] is applied. The fifth transistor TR5 may block the electrical connection between the first power line PL1 and the third node N3 in response to the emission control signal EM [i] with a turn-off level.

The sixth transistor TR6 may be configured to switch the electrical connection between the first node N1 and a fourth node N4. The sixth transistor TR6 may include a gate electrode connected to the emission control line ELi. The sixth transistor TR6 may block the electrical connection between the first node N1 and the fourth node N4 in response to the emission control signal EM [i] with a turn-off level.

The seventh transistor TR7 may be configured to switch the electrical connection between the fourth node N4 and a fourth power line PL4. A second initialization voltage VAINT may be applied to the fourth power line PL4. The seventh transistor TR7 may include a gate electrode connected to an i^{th} fourth sub-gate line SGL4i (hereinafter abbreviated as fourth sub-gate line SGL4i) to which a fourth gate signal GB [i] is applied. The seventh transistor TR7 may electrically connect the fourth node N4 and the fourth power line PL4 in response to the fourth gate signal GB [i] with a turn-on level.

The storage capacitor Cst may include one side electrode and the other side electrode positioned opposite to the one side electrode. The one side electrode may be connected to the second node N2. The other side electrode may consist of the first power line PL1 or may be connected to the first power line PL1. The storage capacitor Cst may be configured to store a voltage applied to the second node N2 for a certain period (for example, one frame period).

The light-emitting element LD may be connected between the fourth node N4 and the second power line PL2. The second power voltage VSS may be applied to the second power line PL2. A node at which the light-emitting element LD is connected to the second power line PL2 may correspond to the second power voltage node VSSN described above in FIG. 2. According to some embodiments, the light-emitting element LD may include the anode AE connected to the fourth node N4 and the cathode CE connected to the second power line PL2. The emission structure EMS may be connected to the anode AE and the cathode CE.

According to some embodiments, the emission structure EMS may include an organic emission layer or an inorganic emission layer. However, embodiments of the present disclosure are not limited thereto.

Referring to FIG. 3, embodiments in which the gate electrode of the fifth transistor TR5 and the gate electrode of the sixth transistor TR6 are connected to the same emission control line ELi is shown. However, embodiments according to the present disclosure are not limited thereto, and the gate electrodes of the fifth transistor TR5 and TR6 may be connected to different emission control lines.

Each of the first to seventh transistors TR1 to TR7 may include a semiconductor layer. The semiconductor layer may include a channel region overlapping the gate electrode, a source region positioned at one side of the channel region, and a drain region positioned at the other side of the channel region.

The third and fourth transistors TR3 and TR4 may each include an N-type semiconductor layer. In a transistor including an N-type semiconductor layer, a high level voltage may be a turn-on level voltage, and a low level voltage may be a turn-off level voltage.

The first, second, and fifth to seventh transistors TR1, TR2, and TR5 to TR7 may each include a P-type semiconductor layer. In a transistor including a P-type semiconductor layer, a low level voltage may be a turn-on level voltage, and a high level voltage may be a turn-off level voltage.

Meanwhile, embodiments of the present disclosure are not limited to those described above, and at least one of the third or fourth transistors TR3 or TR4 may include a P-type semiconductor layer. Alternatively, at least one of the first, second, or fifth to seventh transistors TR1, TR2, or TR5 to TR7 may include an N-type semiconductor layer.

According to some embodiments, the third and fourth transistors TR3 and TR4 may each include an oxide semiconductor. The first, second, and fifth to seventh transistors TR1, TR2, and TR5 to TR7 may each include a silicon semiconductor (for example, a low temperature polycrystalline silicon (LTPS) semiconductor).

According to some embodiments in which the third and fourth transistors TR3 and TR4 each include the oxide semiconductor, the third and fourth transistors TR3 and TR4 may enable relatively reducing leakage current. As a result, a voltage of the second node N2 may be maintained for a relatively long period of time, and thus images may be displayed at various refresh rates (for example, a low refresh rate).

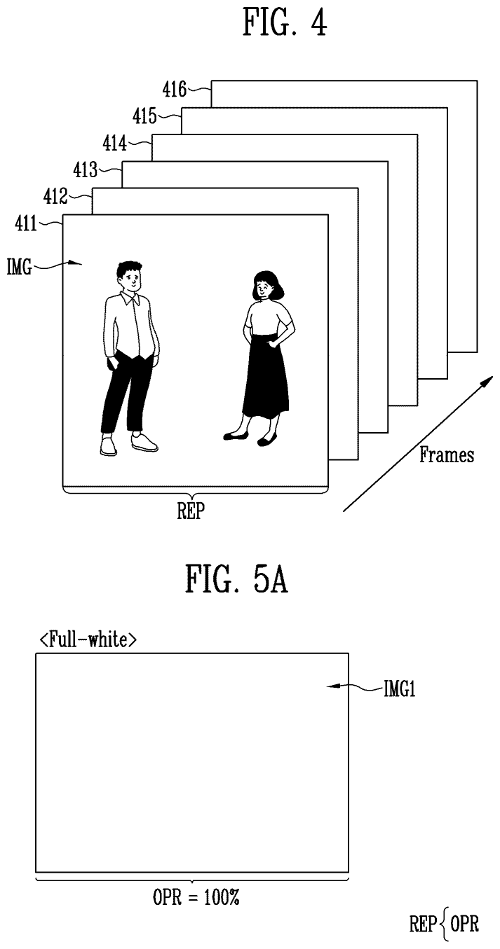

FIG. 4 is a view illustrating an example image being displayed during consecutive frame periods according to some embodiments.

Referring to FIG. 4, for consecutive frames 411 to 416, an image IMG may be displayed for each frame. The image IMG may be a still image or a moving image. The image IMG may have a representative value REP.

The representative value REP of the image IMG may include, for example, an on-pixel ratio (OPR), a current on-pixel ratio (C-OPR), or the like.

The OPR may correspond to an average grayscale value of the image IMG displayed in a corresponding frame. According to some embodiments, the OPR may have a value between 0 and 1 (or between 0% and 100%). The OPR may be calculated based on input image data DATA1 (see FIG. 1).

The C-OPR (or C-OPR value) may correspond to an average luminance value of the image IMG displayed in the corresponding frame. For example, even when the same image is displayed, an image may be displayed at high luminance or low luminance according to a surrounding environment. According to some embodiments, the C-OPR may have a value between 0 and 1 (or between 0% and 100%). The C-OPR may be calculated based on image data DATA2.

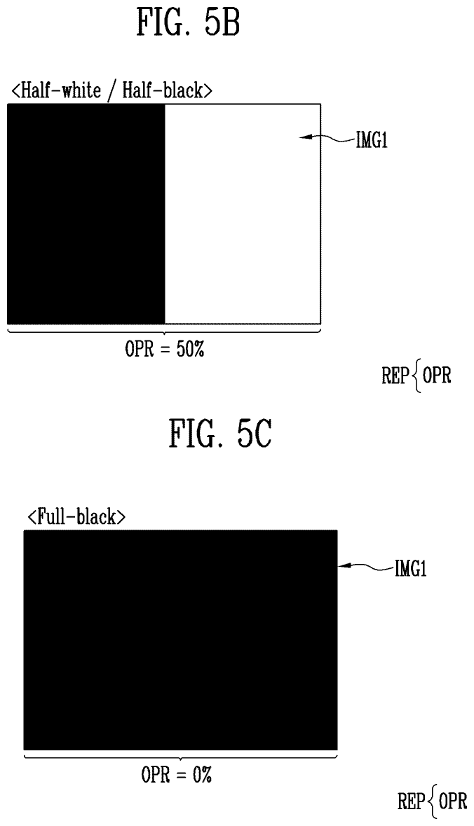

FIGS. 5A, 5B, and 5C are views for describing an OPR.

A representative value REP may include the OPR.

Referring to FIG. 5A, when a first image IMG1 is a full-white image, the OPR may have a value of 100%.

Referring to FIG. 5B, when half of the first image IMG1 is a white image and half thereof is a black image, the OPR may have a value of 50%.

Referring to FIG. 50, when the first image IMG1 is a full-black image, the OPR may have a value of 0%.

According to a grayscale value of the first image IMG1, the OPR of the first image IMG1 may be calculated as a value corresponding to the grayscale value.

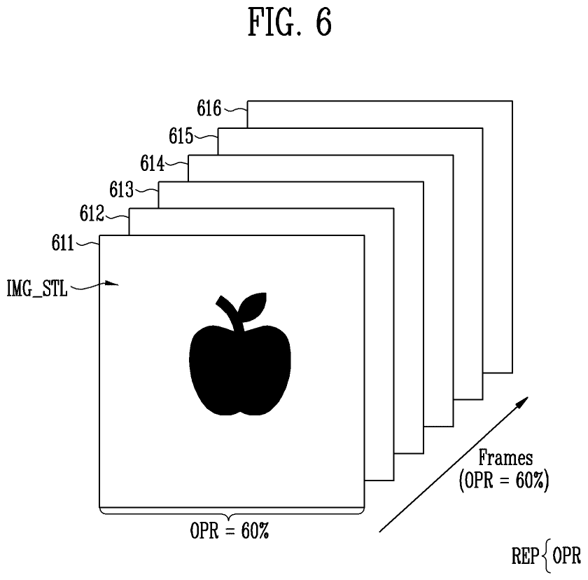

FIG. 6 is a view illustrating an example still image IMG_STL being displayed in consecutive frame periods.

Referring to FIG. 6, the still image IMG_STL may be displayed in consecutive frames 611 to 616.

For example, an OPR of the still image IMG_STL may be 60%. During the consecutive frames 611 to 616, the still image IMG_STL with the OPR of 60% may be consecutively displayed.

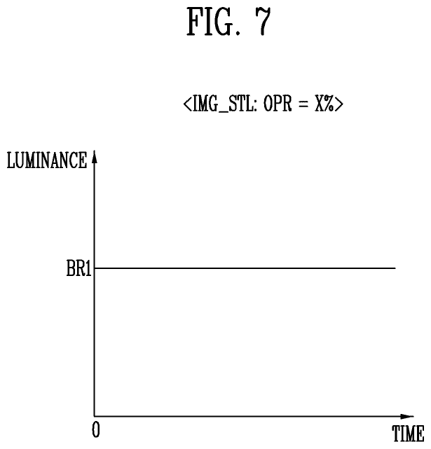

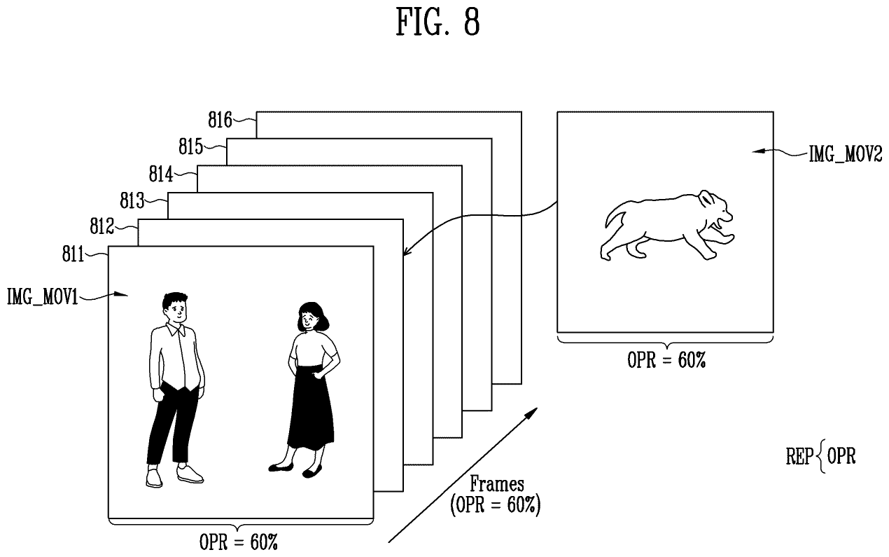

FIG. 7 is a graph showing that luminance is maintained constant while a still (or static) image IMG_STL is displayed according to some embodiments of the present disclosure.

Referring to FIG. 7, while the still image IMG_STL is displayed, luminance may be constantly maintained at a first luminance value BR1. An OPR of the still image IMG_STL may be constant at X % (X is a positive number between 0 and 100).

When luminance changes while the still image IMG_STL is displayed, a user may easily notice a change in luminance of an image. Accordingly, according to some embodiments of the present disclosure, luminance may be maintained constant while the still image IMG_STL is displayed.

FIG. 8 is a view illustrating an example moving image with the same or similar OPR in consecutive frame periods.

Referring to FIG. 8, the moving image may be displayed during consecutive frames 811 to 816. For example, a first image IMG_MOV1 of the moving image may be displayed in a first frame 811, and a second image IMG_MOV2 of the moving image may be displayed in a second frame 812.

The first image IMG_MOV1 and the second image IMG_MOV2 may be different images. Representative values REP of the first image IMG_MOV1 and the second image IMG_MOV2 may be the same or similar. For example, an OPR of the first image IMG_MOV1 and an OPR of the second image IMG_MOV2 may both be 60%.

When watching a moving image with the same or similar OPR during a certain frame period, people do not easily perceive a change in luminance. In the above case, power consumption may be relatively reduced by gradually reducing luminance.

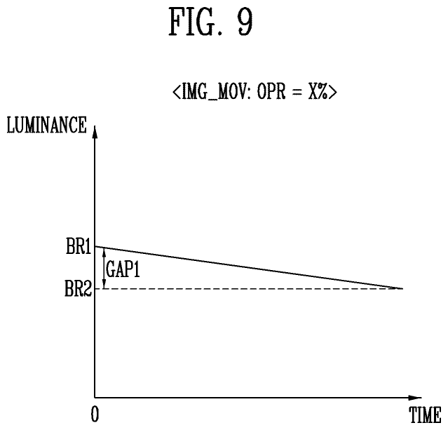

FIG. 9 is a graph showing that luminance decreases while a moving image (or video image) IMG_MOV with the same or similar OPR is displayed according to some embodiments of the present disclosure.

Referring to FIG. 9, in the embodiments of the present disclosure, while the moving image IMG_MOV is displayed, when the OPR is constantly maintained at X %, luminance may be changed from a first luminance value BR1 into a second luminance value BR2 that is smaller than the first luminance value BR1 by a gap GAP1.

According to some embodiments, the luminance may decrease linearly. However, embodiments of the present disclosure are not limited thereto, and the luminance may decrease non-linearly.

According to some embodiments, the luminance may decrease gradually.

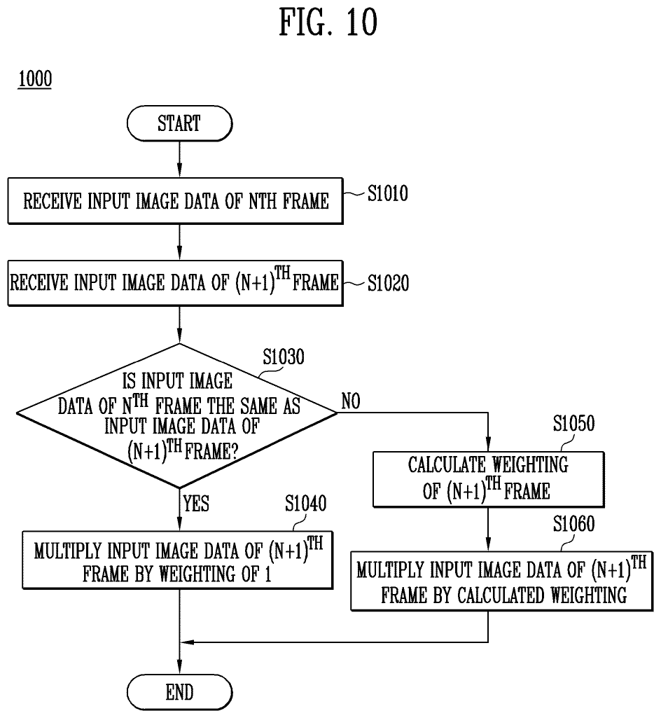

FIG. 10 is a flowchart illustrating aspects of a method 1000 of driving a display device according to some embodiments of the present disclosure. Although FIG. 10 illustrates various operations in a method of driving a display device, embodiments according to the present disclosure are not limited thereto, and according to various embodiments, the method may include additional operations or fewer operations, or the order of operations may vary, without departing from the spirit and scope of embodiments according to the present disclosure.

Referring to FIG. 10, the method 1000 of driving a display device according to some embodiments of the present disclosure may include receiving an input image data of an N^{th} frame (N is an integer of 1 or more) (S1010), receiving an input image data of an (N+1)^{th} frame (S1020), determining whether the input image data of the N^{th} frame is the same as the input image data of the (N+1)^{th} frame (S1030), multiplying the input image data of the (N+1)^{th} frame by a weighting of 1 (S1040), calculating a weighting of the (N+1)^{th} frame (S1050), and multiplying the input image data of the (N+1)^{th} frame by the calculated weighting (S1060).

In receiving the input image data of the N^{th} frame (S1010) and receiving the input image data of the (N+1)^{th} frame (S1020), a controller 150 (see FIG. 1) may receive input image data DATA1 (see FIG. 1).

According to some embodiments, in determining whether the input image data of the N^{th} frame is the same as the input image data of the (N+1)^{th} frame (S1030), representative values REP (see FIG. 4) of the input image data of the N^{th} frame and the input image data of the (N+1)^{th} frame may be compared with each other. According to some embodiments, in determining whether the input image data of the N^{th} frame is the same as the input image data of the (N+1)^{th} frame (S1030), the input image data of the N^{th} frame and the input image data of the (N+1)^{th} frame may be compared with each other line by line. To this end, the controller 150 (see FIG. 1) may be equipped with a frame memory in which the input image data of the N^{th} frame is stored. According to some embodiments, in determining whether the input image data of the N^{th} frame is the same as the input image data of the (N+1)^{th} frame (S1030), the input image data of the N^{th} frame and the input image data of the (N+1)^{th} frame may be compared with each other using a histogram. A comparison method performed in determining whether the input image data of the N^{th} frame is the same as the input image data of the (N+1)^{th} frame (S1030) is not limited to such methods.

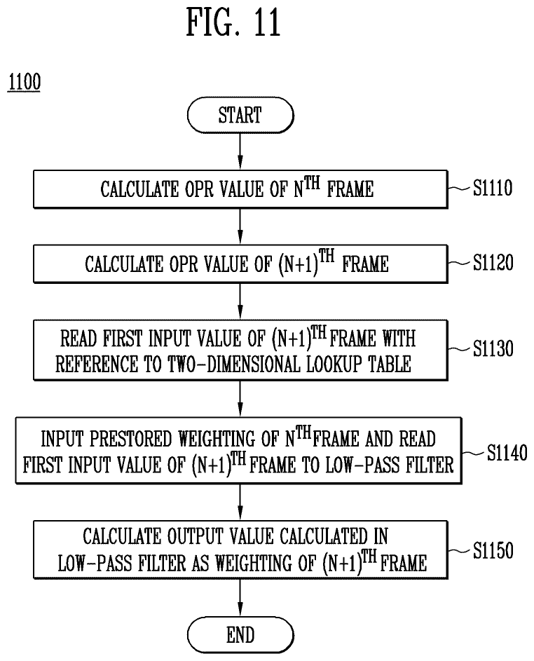

FIG. 11 is a flowchart illustrating aspects of a method 1100 of calculating a weighting of an (N+1)^{th} frame according to some embodiments. Although FIG. 11 illustrates various operations in a method of calculating a weighting of a frame, embodiments according to the present disclosure are not limited thereto, and according to various embodiments, the method may include additional operations or fewer operations, or the order of operations may vary, without departing from the spirit and scope of embodiments according to the present disclosure.

Referring to FIG. 11, aspects of the method 1100 of calculating a weighting of an (N+1)^{th} frame that may be applied to calculating the weighting of the (N+1)th frame (S1050) of FIG. 10 will be described in more detail.

The method 1100 of calculating a weighting of an (N+1)^{th} frame according to some embodiments of the present disclosure may include calculating an OPR (or an OPR value) of an N^{th} frame (S1110), calculating an OPR value of the (N+1)^{th} frame (S1120), reading a first input value of the (N+1)^{th} frame with reference to a two-dimensional lookup table (S1130), inputting a prestored weighting of the N^{th} frame and reading the first input value of the (N+1)^{th} frame to a low-pass filter (S1140), and calculating an output value calculated in the low-pass filter as a weighting of the (N+1)th frame (S1150).

According to some embodiments, each operation shown in FIG. 11 may be performed by the controller 150 of FIG. 1. According to some embodiments, the controller 150 may include a memory including a two-dimensional lookup table. According to some embodiments, the controller 150 may include a circuit or software for implementing a low-pass filter.

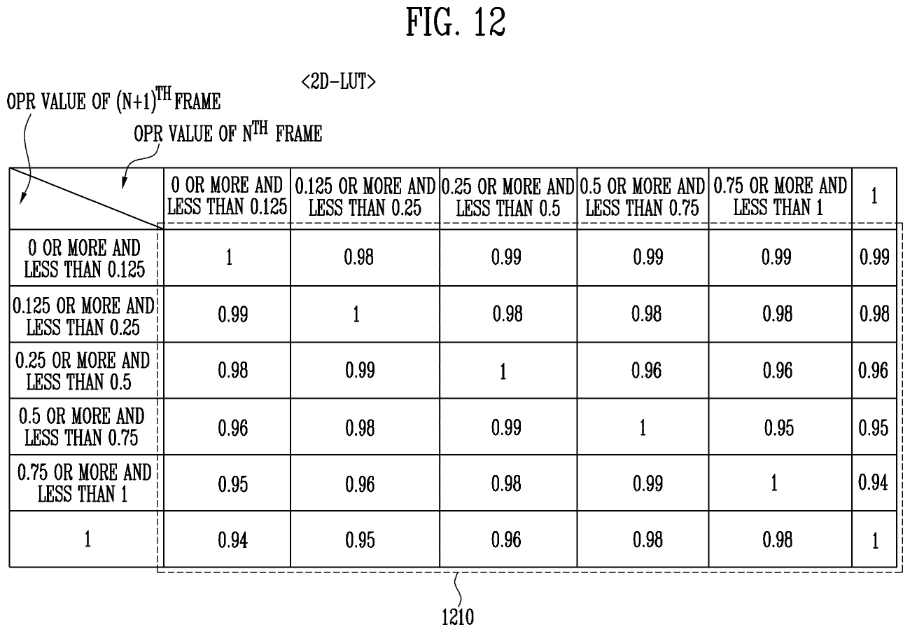

FIG. 12 illustrates an example a two-dimensional lookup table 2D-LUT according to some embodiments.

Referring to FIG. 12, the two-dimensional lookup table 2D-LUT, which may be used in reading the first input value of the (N+1)^{th} frame with reference to the two-dimensional lookup table (S1130) of FIG. 11, is shown.

In the two-dimensional lookup table 2D-LUT, according to the OPR of the N^{th} frame and the OPR of the (N+1)^{th} frame, a corresponding first input value 1210 of the (N+1)^{th} frame may be calculated.

For example, the OPR of the N^{th} frame may be divided into a plurality of sections. For example, the OPR may be divided into a section in which the OPR is 0 or more and less than 0.125, a section in which the OPR is 0.125 or more and less than 0.25, a section in which the OPR is 0.25 or more and less than 0.5, a section in which the OPR is 0.5 or more and less than 0.75, a section in which the OPR is 0.75 or more and less than 1, and a section in which the OPR is 1. However, this is merely one example, and embodiments of the present disclosure are not limited thereto.

According to some embodiments, a section of the OPR of the (N+1)^{th} frame may be set to be the same as that of the OPR of the N^{th} frame. However, embodiments of the present disclosure are not limited thereto, and the section of the OPR of the (N+1)^{th} frame may be set to be different from that of the OPR of the N^{th} frame.

Referring to FIG. 12, when the OPR of the N^{th} frame and the OPR of the (N+1)^{th} frame are similar, the first input value 1210 of the (N+1)^{th} frame may be calculated as 1. The fact that the OPR of the N^{th} frame and the OPR of the (N+1)th frame are similar means that the OPRs of frames are included in the same section of the two-dimensional lookup table 2D-LUT.

For example, when the OPR of the N^{th} frame is 0 or more and less than 0.125, and the OPR of the (N+1)^{th} frame is 0 or more and less than 0.125, the first input value 1210 of the (N+1)^{th} frame may be 1. In the above case, the OPR of the N^{th} frame, and the OPR of the (N+1)^{th} frame may be interpreted as being the same or similar.

Meanwhile, when the OPR of the N^{th} frame and the OPR of the (N+1)^{th} frame are not similar, the first input value 1210 of the (N+1)^{th} frame may be calculated as a value that is less than 1. The fact that the OPR of the N^{th} frame and the OPR of the (N+1)^{th} frame are not similar means that the OPRs of frames are included in different sections of the two-dimensional lookup table 2D-LUT.

For example, when the OPR of the N^{th} frame is 0 or more and less than 0.125, and the OPR of the (N+1)^{th} frame is 0.125 or more and less than 0.25, the first input value 1210 may be 0.99. The above case may be interpreted as a case in which the OPR of the N^{th} frame and the OPR of the (N+1)^{th} frame are not similar.

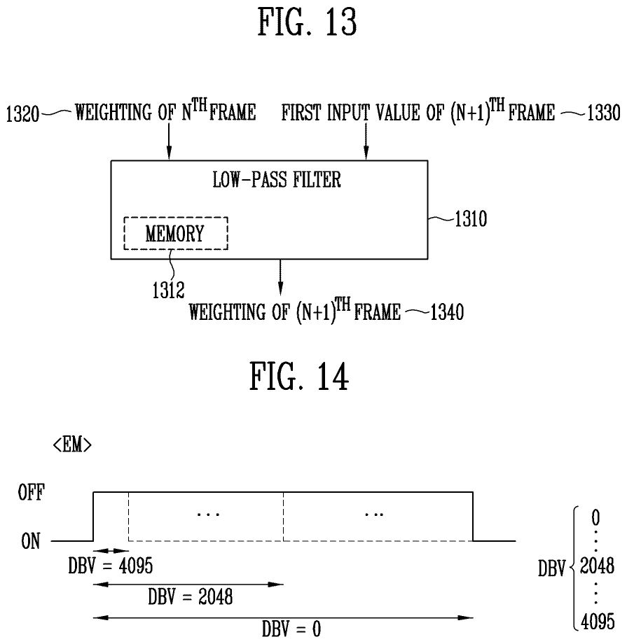

FIG. 13 illustrates aspects of a low-pass filter 1310 according to some embodiments.

Referring to FIG. 13, the low-pass filter 1310 may be configured to receive a weighting 1320 of an N^{th} frame and a first input value 1330 of an (N+1)^{th} frame as inputs and output a weighting 1340 of the (N+1)^{th} frame. The low-pass filter 1310 may be provided as a non-linear recursive filter.

According to some embodiments, the low-pass filter 1310 may be provided as a Kalman filter as shown in Equation 1 below.

$$w ( N + 1 ) = w ( N ) \times ( 1 - C ) + f ( input ) \times C \qquad [ Equation 1 ]$$

In Equation 1, w (N+1) denotes the weighting 1340 of the (N+1)^{th} frame. w(N) denotes the weighting 1320 of the N^{th} frame. f(input) denotes the first input value 1330 of the (N+1)^{th} frame. C may be a parameter of the Kalman filter, and a value between 0 and 1 may be selected by a person skilled in the art.

The parameter of the Kalman filter may be interpreted as a value for reflecting (for example, attenuating and reflecting) the weighting of the N^{th} frame when calculating the weighting of the (N+1)^{th} frame. According to some embodiments of the present disclosure, instances of the weighting 1340 of the (N+1)^{th} frame suddenly changing may be prevented or reduced, thereby functioning to control a sudden change in luminance of an image.

The weighting of the N^{th} frame may be stored in advance. For example, a value calculated by allowing a weighting of an (N−1)^{th} frame and the first input value of the N^{th} frame to pass through the low-pass filter 1310 may be stored in advance.

f(input) may be a value calculated using the two-dimensional lookup table 2D-LUT of FIG. 12 described above.

The low-pass filter 1310 may include a memory 1312 for calculation. The memory 1312 may be, for example, a buffer memory.

Embodiments in which the low-pass filter 1310 is applied as the Kalman filter have been described as an example, but embodiments of the present disclosure are not limited thereto. In addition to the Kalman filter, as the low-pass filter 1310, various types of circuits used in the art may be adopted.

The weighting 1340 of the (N+1)^{th} frame may be generated in calculating the weighting of the (N+1)^{th} frame (S1050) of FIG. 10 described above. The weighting 1340 of the (N+1)^{th} frame may be multiplied by input image data DATA1 (see FIG. 1) of the (N+1)^{th} frame and reflected in image data DATA2 (see FIG. 1) output from a controller 150 (see FIG. 1). Luminance of an image may be maintained or lowered in the manner described above. As a result, power consumption may be relatively reduced within a range in which the display quality of an image viewed by a user is maintained.

FIG. 14 is a diagram illustrating a relationship between widths of a luminance control signal DBV and an emission control signal.

An emission control signal EM may have a turn-on level ON and a turn-off level OFF. According to some embodiments, the turn-on level ON may be a low level, and the turn-off level OFF may be a high level. As a period during which the emission control signal EM has the turn-off level OFF becomes longer, luminance may decrease, and as a period during which the emission control signal EM has the turn-on level ON becomes longer, luminance may increase.

A length of the period during which the emission control signal EM has the turn-off level OFF may vary according to the luminance control signal DBV. For example, the luminance control signal DBV may be included in a control signal CTRL (see FIG. 1) input to a controller 150 (see FIG. 1).

According to some embodiments, the luminance control signal DBV may have a value between 0 and 4,095. For example, when the luminance control signal DBV has a value of 0, the length of the period during which the emission control signal EM has the turn-off level OFF may be the longest. For example, when the luminance control signal DBV has a value of 4,095, the length of the period during which the emission control signal EM has the turn-off level OFF may be shortest. For example, when the luminance control signal DBV has a value of 2,048 which is between 0 and 4,095, the length of the period during which the emission control signal EM has the turn-off level OFF may be medium.

However, embodiments of the present disclosure are not limited thereto, and a value range of the luminance control signal DBV may be changed in various ways.

Accordingly, luminance may be adaptively adjusted separately from input image data DATA1 (see FIG. 1).

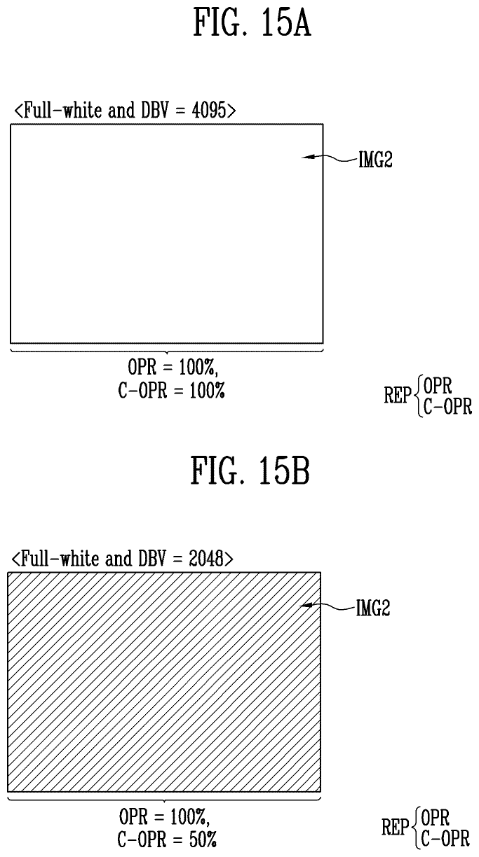

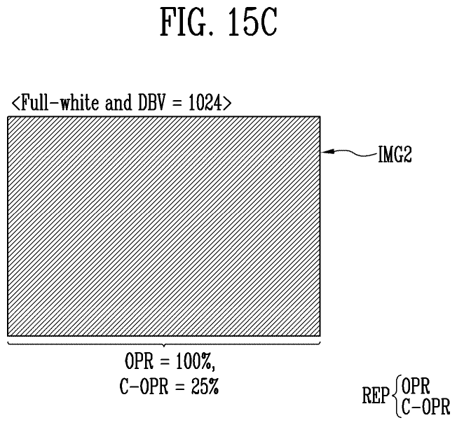

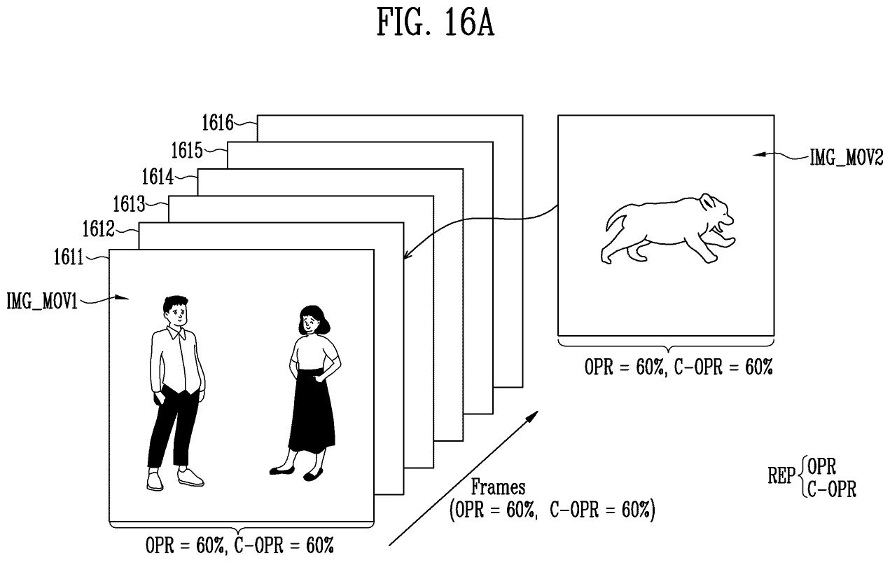

FIGS. 15A, 15B, and 15C are views for describing a relationship between a luminance control signal DBV, an OPR, and a C-OPR.

Referring to FIG. 15A, when a full-white image is displayed, the OPR may have a value of 100%. At the same time, when the luminance control signal DBV has a value of 4,095, a second image IMG2 may be displayed as a full-white image with the brightest luminance. In this case, the C-OPR may have a value of 100%.

Referring to FIG. 15B, when the luminance control signal DBV has a value of 2,048 while a full-white image is displayed, the second image IMG2 may be displayed at luminance that is about half of that of the full-white image. In this case, the C-OPR may have a value of 50%.

Referring to FIG. 15C, when the luminance control signal DBV has a value of 1,024 while a full-white image is displayed, the second image IMG2 may be displayed at luminance that is about ¼ of that of the full-white image. In this case, the C-OPR may have a value of 25%.

Referring to this, it may be understood that the C-OPR is calculated by multiplying the OPR by a certain ratio. The certain ratio corresponds to a value obtained by dividing a value of the luminance control signal DBV by 4,096, wherein 4,096 may correspond to a maximum value of the luminance control signal DBV.

A representative value REP may include the OPR and the C-OPR.

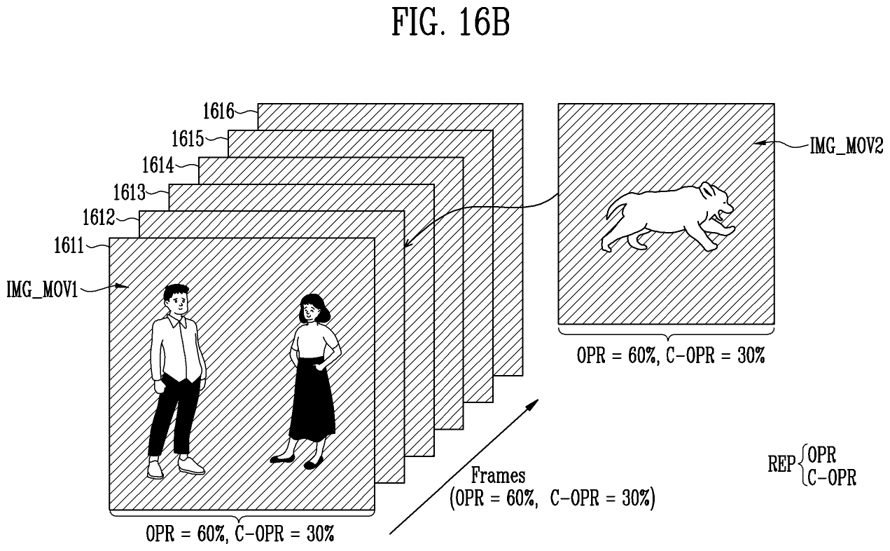

FIGS. 16A and 16B are views illustrating a change in image luminance according to a change in C-OPR according to some embodiments.

Referring to FIG. 16A, a moving may be displayed during consecutive frames 1611 to 1616. For example, a first image IMG_MOV1 of the moving image may be displayed in a first frame 1611, and a second image IMG_MOV2 of the moving image may be displayed in a second frame 1612.

An OPR of each of the first image IMG_MOV1 and the second image IMG_MOV2 may be 60%. Each C-OPR may be 60%.

Referring to FIG. 16B, the OPR of each of the first image IMG_MOV1 and the second image IMG_MOV2 may be 60%. Each C-OPR may be 30%.

The image displayed in FIG. 16A and the image displayed in FIG. 16B may be substantially the same image, but the C-OPRs thereof may be different.

Meanwhile, while an image with relatively high luminance is displayed, people do not easily perceive that the luminance of the image is lowered. However, while an image with relatively low luminance is displayed, people may easily perceive that the luminance of the image is lowered.

According to some embodiments of the present disclosure, even when images with the same OPR are displayed, when a C-OPRs are different, a luminance change amount may be controlled differently, thereby relatively reducing consumption within a range within which display quality is maintained.

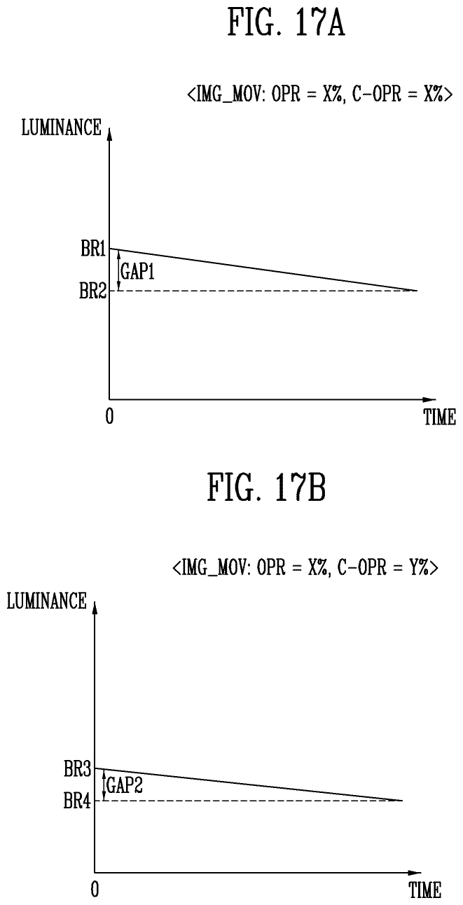

FIGS. 17A and 17B are graphs showing that a luminance change amount varies according to a C-OPR according to some embodiments of the present disclosure.

Referring to FIG. 17A, according to some embodiments of the present disclosure, while a moving image IMG_MOV is displayed, an OPR is constantly maintained at X %, and the C-OPR value is constantly maintained at X %, luminance may be changed from a first luminance value BR1 into a second luminance value BR2 by as small as a gap GAP1. The above embodiments may be applied not only when the OPR is constantly maintained at X %, but also when the OPR is maintained in a range that is similar to X %. In addition, the above embodiments may be applied not only when the C-OPR is constantly maintained at X %, but also when the C-OPR is maintained in a range that is similar to X %.

Referring to FIG. 17B, according to some embodiments of the present disclosure, while the moving image IMG_MOV is displayed, the OPR is constantly maintained at X %, and the C-OPR value is constantly maintained at Y %, luminance may be changed from a third luminance value BR3 into a fourth luminance value BR4 by as small as a second gap GAP2. The above embodiments may be applied not only when the OPR is constantly maintained at X %, but also when the OPR is maintained in a range that is similar to X %. In addition, the above embodiments may be applied not only when the C-OPR is constantly maintained at Y %, but also when the C-OPR is maintained in a range that is similar to Y %.

A size of the second gap GAP2 may be smaller than a size of the first gap GAP1.

According to some embodiments of the present disclosure, as the C-OPR is decreased, an amount of luminance reduction per unit time may be decreased. Thus, power consumption may be relatively reduced within a range in which display quality does not deteriorate.

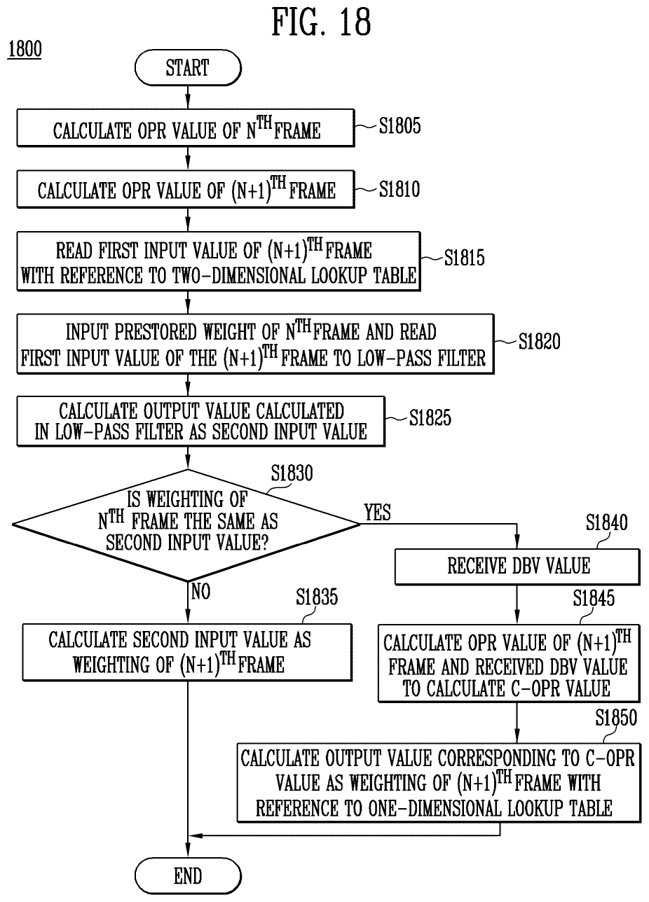

FIG. 18 is a flowchart illustrating aspects of a method 1800 for calculating a weighting of an (N+1)^{th} frame according to some embodiments. Although FIG. 18 illustrates various operations in a method of calculating a weighting of a frame, embodiments according to the present disclosure are not limited thereto, and according to various embodiments, the method may include additional operations or fewer operations, or the order of operations may vary, without departing from the spirit and scope of embodiments according to the present disclosure.

Referring to FIG. 18, aspects of the method 1800 of calculating a weighting of an (N+1)^{th} frame that may be applied to calculating the weighting of the (N+1)th frame (S1050) of FIG. 10 will be described in more detail.

The method 1800 of calculating a weighting of an (N+1)^{th} frame according to some embodiments of the present disclosure may include calculating an OPR of an N^{th} frame (S1805), calculating an OPR of an (N+1)^{th} frame (S1810), reading a first input value of the (N+1)^{th} frame with reference to a two-dimensional lookup table (S1815), inputting a prestored weighting of the N^{th} frame and the reading a first input value of the (N+1)^{th} frame to a low-pass filter (S1820), calculating an output value calculated in the low-pass filter as a second input value (S1825), determining whether the weighting of the N^{th} frame is the same as the second input value (S1830), applying the second input value as a weighting of the (N+1)^{th} frame (S1835), receiving a luminance control signal DBV value (S1840), calculating the OPR value of the (N+1)^{th} frame and a value of the received luminance control signal DBV to calculate a C-OPR value (S1845), and calculating an output value corresponding to the C-OPR as the weighting of the (N+1)th frame with reference to a one-dimensional lookup table (S1850).

In the flowchart of FIG. 18, calculating the OPR value of the N^{th} frame (S1805), calculating the OPR value of an (N+1)^{th} frame (S1810), reading the first input value of the (N+1)^{th} frame with reference to the two-dimensional lookup table (S1815), and inputting the prestored weighting of the N^{th} frame and the reading a first input value of the (N+1)^{th} frame to the low-pass filter (S1820) may be substantially the same as calculating the OPR value of the N^{th} frame (S1110), calculating the OPR of the (N+1)^{th} frame (S1120), reading the first input value of the (N+1)^{th} frame with reference to the two-dimensional lookup table (S1130), and inputting a prestored weighting of the N^{th} frame and the reading the first input value of the (N+1)^{th} frame to the low-pass filter (S1140) described above with reference to FIG. 11, respectively.

As compared to the embodiments of FIG. 11, in the embodiments of FIG. 18, the output value calculated in the low-pass filter may be calculated as the second input value without being applied as a weighting.

In the embodiments of FIG. 18, determining whether the weighting of the N^{th} frame is the same as the second input value (S1830) may be performed. When the weighting of the N^{th} frame is the same as the second input value, the output value calculated in the low-pass filter may be applied as the weighting of the (N+1)^{th} frame.

When the weighting of the N^{th} frame is not the same as the second input value, receiving the luminance control signal DBV value (S1840) may be performed.

Thereafter, the C-OPR may be calculated by performing a calculation based on the OPR of the (N+1)^{th} frame and the received luminance control signal DBV.

Based on the calculated C-OPR, the output value corresponding to the C-OPR may be applied as the weighting of the (N+1)^{th} frame with reference to the one-dimensional lookup table.

According to some embodiments of the present disclosure, luminance may be adaptively adjusted according to the C-OPR. Thereby, power consumption may be relatively reduced.

According to some embodiments, each operation shown in FIG. 18 may be performed by a controller 150 (see FIG. 1).

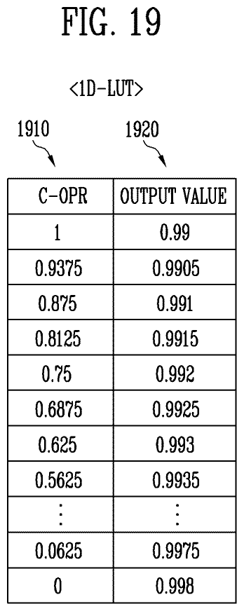

FIG. 19 illustrates an example of a one-dimensional lookup table 1D-LUT according to some embodiments.

Referring to FIG. 19, the one-dimensional lookup table 1D-LUT may include a C-OPR and output values 1920 corresponding thereto.

Values of the C-OPR shown in the one-dimensional look-up table 1D-LUT may represent representative values of corresponding sections. For example, in embodiments in which a representative value is the minimum value, a section corresponding to 0 may represent a section in which the C-OPR is 0 or more and less than 0.0625. For example, a section corresponding to 0.0625 may represent a section in which the C-OPR is 0.0625 or more and less than 0.125. However, embodiments of the present disclosure are not limited thereto, and a representative value of a corresponding section may be a middle value, an average value, or a maximum value of the section.

According to some embodiments, for a section in which a representative value of the C-OPR is 1, an output value 1920 may be 0.99. In the above case, in a section in which the C-OPR is 1, a weighting of an (N+1)^{th} frame may be set to 0.99.

According to some embodiments, for a section in which a representative value of the C-OPR is 0.9375, the output value 1920 may be 0.9905. In the above case, in a section in which the C-OPR is 0.9375, the weighting of the (N+1)^{th} frame may be set to 0.9905.

Accordingly, as the C-OPR decreases, the weighting of the (N+1)^{th} frame may gradually increase. Accordingly, luminance may be controlled to slowly decrease during a plurality of frames in which an image with low luminance is displayed.

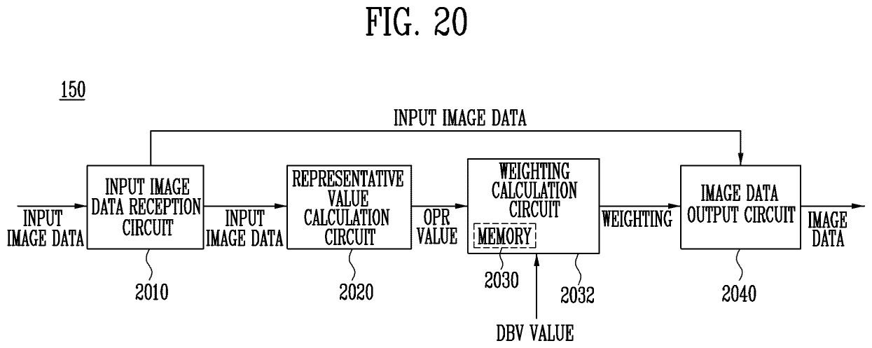

FIG. 20 is a block diagram illustrating aspects of a controller 150 according to some embodiments of the present disclosure.

Referring to FIG. 20, the controller 150 according to some embodiments of the present disclosure may include an input image data reception circuit 2010, a representative value calculation circuit 2020, a weighting calculation circuit 2030, and an image data output circuit 2040.

The input image data reception circuit 2010 may receive input image data DATA1 (see FIG. 1) from an external source (for example, a host or an application processor).

The representative value calculation circuit 2020 may receive the input image data DATA1 (see FIG. 1) and calculate a representative value. The calculated representative value may include, for example, an OPR.

The weighting calculation circuit 2030 may receive the calculated OPR and generate a weighting based on the received OPR. According to some embodiments, the weighting calculation circuit 2030 may generate a weighting of an (N+1)^{th} frame based on a prestored weighting of an N^{th} frame and the received OPR of the (N+1)th frame. According to some embodiments, the weighting calculation circuit 2030 may further receive a luminance control signal DBV and may generate the weighting of the (N+1)^{th} frame with further reference to a C-OPR (see FIG. 19) of the (N+1)^{th} frame calculated based on the luminance control signal DBV. The weighting calculation circuit 2030 may include a memory 2032, and a two-dimensional lookup table 2D-LUT (see FIG. 12), a one-dimensional lookup table 1D-LUT (see FIG. 19), or the like may be stored in the memory 2032.

The image data output circuit 2040 may multiply the received input image data DATA1 (see FIG. 1) by a received weighting and may output image data DATA2 (see FIG. 1) corresponding to the (N+1)^{th} frame. As a result, there may be provided a display device 100 (see FIG. 1) with relatively reduced power consumption without degradation in display quality.

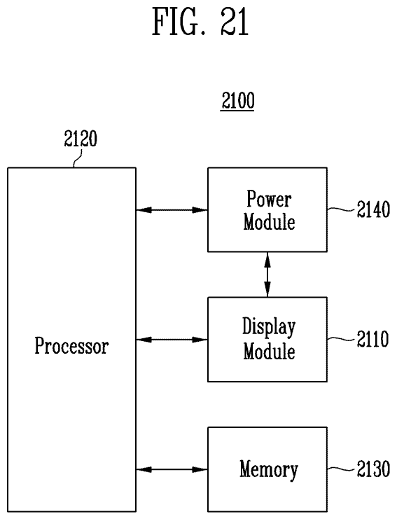

FIG. 21 is a block diagram of an electronic device 2100 according to an embodiment of the present disclosure.

Referring to FIG. 21, the electronic device 2100 according to an embodiment may include a display module 2110, a processor 2120, a memory 2130, and a power module 2140.

The processor 2120 may include at least one of a central processing unit (CPU), an application processor (AP), a graphics processing unit (GPU), a communication processor (CP), an image signal processor (ISP), and a controller.

The memory 2130 may store data information necessary for operation of the processor 2120 or the display module 2110. When the processor 2120 executes an application stored in the memory 2130, image data signals and/or an input control signal are transmitted to the display module 2110, and the display module 2110 may process the received signal to output image information through a display screen.

The power module 2140 may include a power supply module such as a power adapter or battery device, and a power conversion module that converts power supplied by the power supply module to generate the power required for operation of the electronic device 2100.

At least one of the above-described components of the electronic device 2100 may be included in the display device 100 (see FIG. 1) according to the above-described embodiments. In addition, some of the individual modules that are functionally included in one module may be included in the display device 100, and others may be provided separately from the display device 100. For example, display device 100 may include display module 2110, while processor 2120, memory 2130, and power module 2140 may be provided in the form of other devices in electronic device 2100 other than the display device 100.

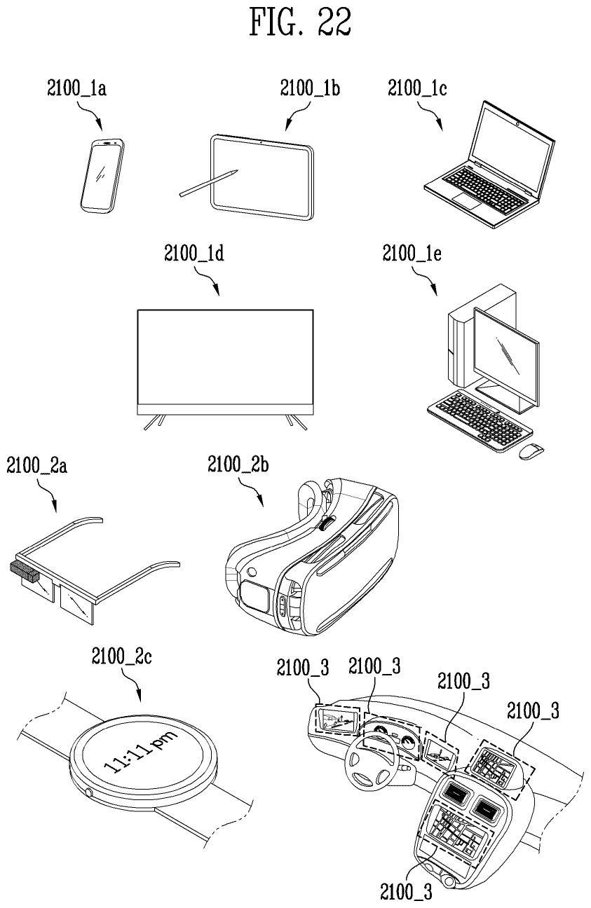

FIG. 22 is a schematic illustration of an electronic device 2100 according to various embodiments.

Referring to FIG. 22, various electronic devices to which a display device according to embodiments is applied may include not only an electronic device for displaying an image such as a smartphone 2100_1a, a tablet PC 2100_1b, a laptop 2100_1c, a TV 2100_1d, and a desk monitor 2100_1e, but also a wearable electronic device including a display module such as smart glasses 2100_2a, a head mounted display 2100_2b, and a smart watch 2100_2c, a vehicle electronic device 2100_3 including a display module, such as a CID (Center Information Display) disposed on an instrument panel, a center fascia, and a dashboard of a vehicle, a room mirror display, and the like.

According to a controller, a display device including the same, and an electronic device including the same according to some embodiments of the present disclosure, the power consumption of a display device can be relatively reduced within a range in which the display quality of an image provided by the display device is not degraded.

The drawings and detailed description of the invention described so far are merely illustrative of the present disclosure and are merely intended to describe the present disclosure and are not intended to limit the meanings thereof or the scope of the present disclosure described in the accompanying claims. Therefore, those skilled in the art will appreciate that various modifications and other equivalent embodiments are possible from the embodiments. Therefore, the technical scope of embodiments according to the present disclosure should be defined by the appended claims, and their equivalents.

What is claimed is:

1. A controller comprising:
an input image data reception circuit configured to receive input image data including a grayscale value of a pixel;
a representative value calculation circuit configured to calculate an on-pixel ratio from the received input image data;
a weighting calculation circuit configured to calculate a weighting corresponding to the input image data based on the calculated on-pixel ratio; and
an image data output circuit configured to output image data generated by multiplying the input image data by the calculated weighting.

2. The controller of claim 1, wherein the input image data reception circuit is configured to receive input image data of an N^{th} frame (N is an integer of 1 or more) and input image data of an (N+1)^{th} frame and to determine whether or not the received input image data of the N^{th} frame is the same as the received input image data of the (N+1)^{th} frame.

3. The controller of claim 2, wherein, based on the input image data of the N^{th} frame being the same as the input image data of the (N+1)^{th} frame, the weighting calculation circuit is configured to calculate 1 as a weighting corresponding to the input image data of the (N+1)^{th} frame.

4. The controller of claim 2, wherein, based on the input image data of the N^{th} frame being different from the input image data of the (N+1)^{th} frame, the representative value calculation circuit is configured to calculate an on-pixel ratio of the N^{th} frame and an on-pixel ratio of the (N+1)^{th} frame.

5. The controller of claim 4, wherein the weighting calculation circuit is configured to read a first input value corresponding to the on-pixel ratio of the N^{th} frame and the on-pixel ratio of the (N+1)^{th} frame with reference to a two-dimensional lookup table and to input a prestored weighting of the N^{th} frame and the read first input value to a low-pass filter.

6. The controller of claim 5, wherein the weighting calculation circuit is configured to calculate an output value calculated in the low-pass filter as a weighting of the (N+1)^{th} frame.

7. The controller of claim 5, wherein the weighting calculation circuit is configured to calculate an output value calculated in the low-pass filter as a second input value and to determine whether or not the prestored weighting of the N^{th} frame is the same as the second input value.

8. The controller of claim 7, wherein, based on the prestored weighting of the N^{th} frame being the same as the second input value, the weighting calculation circuit is configured to calculate the second input value as a weighting of the (N+1)^{th} frame.

9. The controller of claim 7, wherein, based on the prestored weighting of the N^{th} frame being different from the second input value, the weighting calculation circuit is further configured to receive a luminance control signal and to calculate the on-pixel ratio of the (N+1)^{th} frame and the received luminance control signal to calculate a current on-pixel ratio.

10. A display device comprising:
a display panel on which a plurality of pixels are located;
1 a data driver configured to receive image data and supply data signals to data lines connected to the plurality of pixels based on the received image data; and
a controller configured to receive input image data, to calculate an on-pixel ratio from the received input image data, to calculate a weighting corresponding to the input image data based on the calculated on-pixel ratio, and to output image data generated by multiplying the input image data by the calculated weighting.

11. The display device of claim 10, wherein the controller is configured to receive input image data of an N^{th} frame (N is an integer of 1 or more) and input image data of an (N+1)^{th} frame and to determine whether or not the received input image data of the N^{th} frame is the same as the received input image data of the (N+1)^{th} frame.

12. The display device of claim 11, wherein, based on the input image data of the N^{th} frame being the same as the input image data of the (N+1)^{th} frame, the controller is configured to calculate 1 as a weighting corresponding to the input image data of the (N+1)^{th} frame.

13. The display device of claim 11, wherein, based on the input image data of the N^{th} frame being different from the input image data of the (N+1)^{th} frame, the controller is configured to calculate an on-pixel ratio of the N^{th} frame and an on-pixel ratio of the (N+1)^{th} frame.

14. The display device of claim 13, wherein the controller is configured to read a first input value corresponding to the on-pixel ratio of the N^{th} frame and the on-pixel ratio of the (N+1)^{th} frame with reference to a two-dimensional lookup table and to input a prestored weighting of the N^{th} frame and the read first input value to a low-pass filter.

15. The display device of claim 14, wherein the two-dimensional lookup table is stored in the controller,
wherein, in the stored two-dimensional lookup table, based on the on-pixel ratio of the N^{th} frame being the same or similar to the on-pixel ratio of the (N+1)^{th} frame, the first input value has a value of 1, and
based on the on-pixel ratio of the N^{th} frame not being the same or similar to the on-pixel ratio of the (N+1)^{th} frame, the first input value has a value that is less than 1.

16. The display device of claim 14, wherein the low-pass filter is a Kalman filter.

17. The display device of claim 14, wherein the controller calculates an output value calculated in the low-pass filter as a weighting of the (N+1)^{th} frame.

18. The display device of claim 14, wherein the controller is configured to calculate an output value calculated from the low-pass filter as a second input value and to determine whether or not the prestored weighting of the N^{th} frame is the same as the second input value.

19. The display device of claim 18, wherein, based on the prestored weighting of the N^{th} frame being the same as the second input value, the controller is configured to calculate the second input value as a weighting of the (N+1)^{th} frame, and based on the prestored weighting of the N^{th} frame being different from the second input value, the controller is further configured to receive a luminance control signal and to calculate the on-pixel ratio of the (N+1)^{th} frame and the received luminance control signal to calculate a current on-pixel ratio.

20. An electronic device comprising:
a processor configured to output an input image data;
a display panel on which a plurality of pixels are located;
a data driver configured to receive image data and supply data signals to data lines connected to the plurality of pixels based on the received image data; and
a controller configured to receive the input image data, to calculate an on-pixel ratio from the received input image data, to calculate a weighting corresponding to the input image data based on the calculated on-pixel ratio, and to output the image data generated by multiplying the input image data by the calculated weighting.
